(19) United States
(12) Patent Application Publication
(10) Pub. No.: US 2023/0046961 A1
(43) Pub. Date: Feb. 16, 2023

(54) PROGRAM GENERATION APPARATUS, PROGRAM GENERATION METHOD AND PROGRAM

(71) Applicant: NIPPON TELEGRAPH AND TELEPHONE CORPORATION, Tokyo (JP)

(72) Inventors: Toshiyuki KURABAYASHI, Tokyo (JP); Hiroyuki KIRINUKI, Tokyo (JP)

(73) Assignee: NIPPON TELEGRAPH AND TELEPHONE CORPORATION, Tokyo (JP)

(21) Appl. No.: 17/793,007

(22) PCT Filed: Jan. 16, 2020
(86) PCT No.: PCT/JP2020/001206

§ 371 Date: Jul. 14, 2022

(51) Int. Cl. G06F 8/41; G06F 8/33; G06F 40/40

(52) U.S. Cl. CPC G06F 8/425; G06F 8/33; G06F 40/40

(57) ABSTRACT

A program generation apparatus includes a generation unit that inputs a specification of a program to be generated described in natural language into a model trained on a relationship between a specification of a program described in natural language and the program to generate a first program, and a change unit that changes the first program to generate a second program satisfying a set of one or more input values and output values, and thus the possibility of a desired program being automatically generated can be increased.

### TECHNICAL FIELD

The present invention relates to a program generation apparatus, a program generation method, and a program.

### BACKGROUND ART

In recent years, while introduction of IT has advanced in the whole society, the shortage of IT engineers has become a serious issue. The Ministry of Economy, Trade and Industry predicts that there will be a shortage of approximately 360,000 IT engineers in 2025. In particular, a shortage of IT engineers in implementation processes that require specialized knowledge is an urgent issue, and thus research and development for an automatic programming technique for automatic programming have been awaited.

In the related art, known automatic programming techniques include automatic programming using natural language, and automatic programming using input/output examples.

Automatic programming using natural language automatically generates a program in accordance with a specification described by a user in natural language. For example, NPL 1 discloses a technique that enables automatic generation of a program in natural language by training a machine translation model on a relationship between natural language and a corresponding program.

In automatic programming using input/output examples, a user provides one or more specific input/output examples of the program, and components of the program are synthesized to satisfy the input/output examples. For example, NPL 2 discloses a technique for automatically synthesizing Excel (trade name) functions satisfying given input/output examples.

### CITATION LIST

### Non Patent Literature

NPL 1: Hiroyuki Fudaba, Yusuke Oda, Graham Neubig, Koichiro Yoshino, Tetsu Nakamura, “Generation of Source Code from Natural Language Using Statistical Machine Translation”, Proceedings of the 22nd Annual Conference of the Association for Natural Language Processing (March 2016), [online], Internet <UPR: https://ahcweb01.naist.jp/papers/conference/2015/201603_NLP_Fudaba_1/201603_NLP_Fuda ba_1.paper.pdf>

NPL 2: Sumit Gulwani, “Automating String Processing in Spreadsheets Using input/output Examples”, POPL '11 Proceedings of the 38th Annual ACM SIGPLAN-SIGACT Symposium on Principles of Programming Languages, p. 317-330, [online], Internet <URL: https://dl.acm.org/citation.cfm?Id=1926423>

### SUMMARY OF THE INVENTION

### Technical Problem

However, it is difficult to generate a correct program from ambiguous information of natural language, and even if the structure of the entire program is close to a correct structure, it is highly likely that an incorrect program is generated for processing detailed parts.

In addition, the input/output example is merely an example of a specification satisfied by the program and has a disadvantage of having a small amount of information. As a result, it is highly likely that a program overfitting to input/output examples is generated.

The present invention has been conceived in view of the above-described circumstances and aims to increase the possibility of a desired program being automatically generated.

### Means for Solving the Problem

To solve the above-described problem, a program generation apparatus includes a generation unit that inputs a specification of a program to be generated described in natural language into a model trained on a relationship between a specification of a program described in the natural language and the program to generate a first program, and a change unit that changes the first program to generate a second program satisfying a set of one or more input values and output values.

### Effects of the Invention

The possibility of a desired program being automatically generated can be increased.

### BRIEF DESCRIPTION OF DRAWINGS

FIG. 1 is a diagram illustrating a hardware configuration example of a program generation apparatus 10 according to an embodiment of the present invention.

FIG. 2 is a diagram illustrating a functional configuration example of the program generation apparatus 10 according to the embodiment of the present invention.

FIG. 3 is a flowchart for explaining an example of a processing procedure executed by the program generation apparatus 10.

FIG. 4 is a flowchart for explaining an example of a processing procedure of a generation model training process.

FIG. 5 is a diagram illustrating an example of a training data set.

FIG. 6 is a flowchart for explaining an example of a processing procedure of a template code generation process.

FIG. 7 is a diagram illustrating a specific example of the template code generation process.

FIG. 8 is a flowchart for explaining an example of a processing procedure of a program synthesis process.

FIG. 9 is a diagram illustrating an example of an input/output example set.

FIG. 10 is a diagram illustrating an example of a program component list.

FIG. 11 is a diagram illustrating an example of a synthetic code generated in a synthetic code change process.

### DESCRIPTION OF EMBODIMENTS

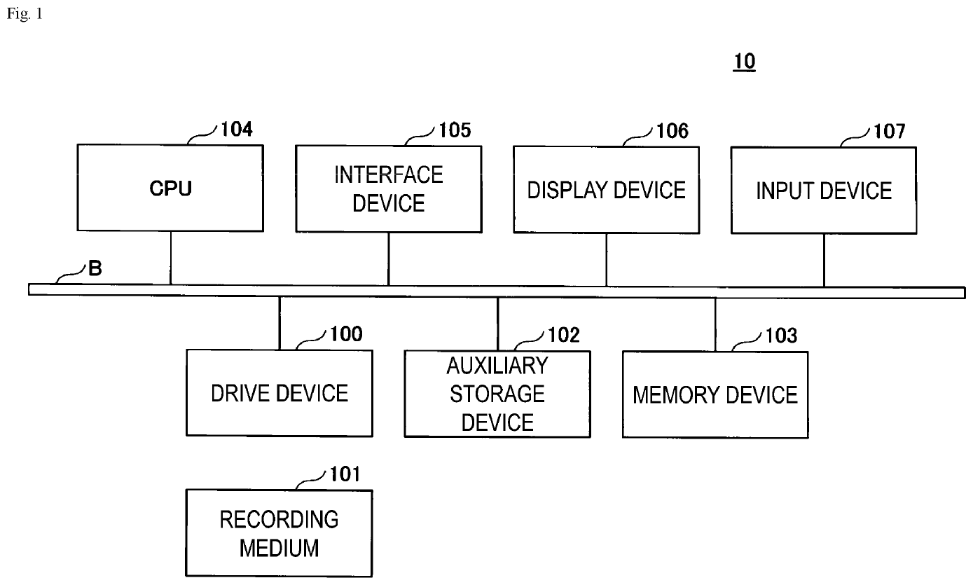

Hereinafter, embodiments of the present disclosure will be described with reference to the drawings. FIG. 1 is a diagram illustrating a hardware configuration example of a program generation apparatus 10 according to an embodiment of the present invention. The program generation apparatus 10 of FIG. 1 includes a drive device 100, an auxiliary storage device 102, a memory device 103, a CPU 104, an interface device 105, a display device 106, an input device 107, and the like, which are connected to one another by a bus B.

A program that implements processing of the program generation apparatus 10 is provided in a recording medium 101 such as a CD-ROM. When the recording medium 101 storing the program is set in the drive device 100, the program is installed in the auxiliary storage device 102 from the recording medium 101 via the drive device 100. However, the program does not necessarily have to be installed from the recording medium 101 and may be downloaded from another computer via a network. The auxiliary storage device 102 stores the installed program and also stores necessary files, data, and the like.

The memory device 103 reads and stores the program from the auxiliary storage device 102 when there is an instruction to start the program. The CPU 104 realizes functions of the program generation apparatus 10 according to the program stored in the memory device 103. The interface device 105 is used as an interface for connection to a network. The display device 106 displays a graphical user interface (GUI) according to the program or the like. The input device 107 is configured as a keyboard, a mouse, and the like, and is used for inputting various operation instructions.

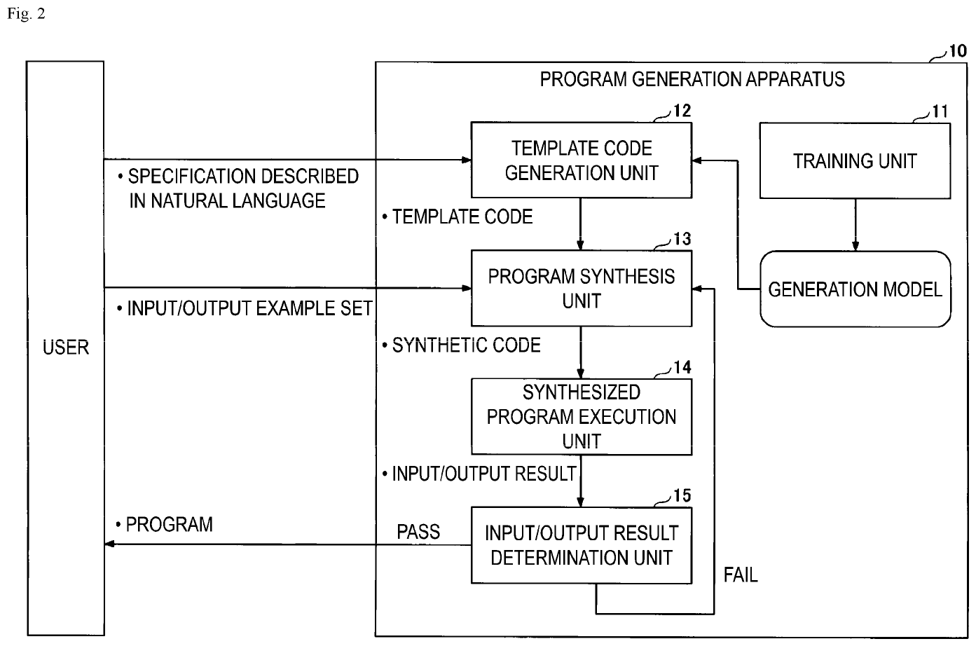

FIG. 2 is a diagram illustrating a functional configuration example of the program generation apparatus 10 according to the embodiment of the present invention. In FIG. 2, the program generation apparatus 10 includes a training unit 11, a template code generation unit 12, a program synthesis unit 13, a synthesized program execution unit 14, and an input/output result determination unit 15. Each of these units is realized by one or more programs installed in the program generation apparatus 10 causing the CPU 104 to execute processing.

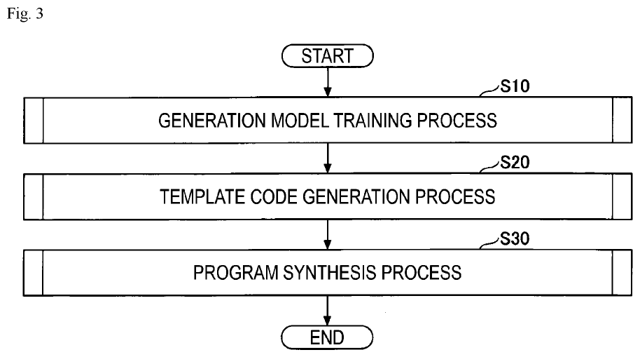

Hereinafter, a processing procedure executed by the program generation apparatus 10 will be described. FIG. 3 is a flowchart for explaining an example of a processing procedure executed by the program generation apparatus 10.

In step S10, the training unit 11 trains a model configured with a neural network such as a recurrent neural network (RNN) (hereinafter referred to as a “generation model”) on the relationship between a specification described in natural language and (the source code of) a program.

Subsequently, the template code generation unit 12 performs a template code generation process (S20). In the template code generation process, the specification of a program to be generated (which will be referred to as a “target program”) described in natural language is input to the generation model trained in step S10, and thus the source code (which will be referred to as a “template code” below) of the original (source) program of the target program is generated. Further, step S20 may be performed asynchronously with respect to step S10. In addition, the template code generation process may be performed using the technique disclosed in NPL 1.

Next, the program synthesis unit 13, the synthesized program execution unit 14, and the input/output result determination unit 15 perform a program synthesis process (S30). In the program synthesis process, some of the template codes are repeatedly changed (parts of the template codes are changed in a cumulative manner) based on the template code generated in the template code generation process until a program satisfying an input/output example (a set of one or more input values and output values) is generated, and thus the target program satisfying the specification (the intention of the creator) is automatically generated.

That is, in the present embodiment, using the two types of information including the specification of the target program described in natural language and the input/output example increases the possibility of the program conforming to the specification being generated.

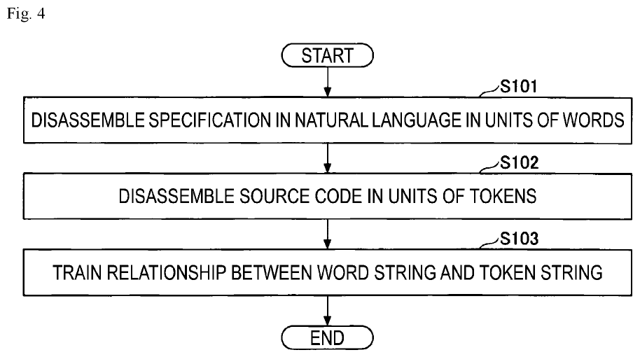

Next, details of step S10 in FIG. 3 will be described. FIG. 4 is a flowchart for explaining an example of the processing procedure of the generation model training process.

In step S101, the training unit 11 disassembles (divides) the specification of the program described in natural language included in each piece of training data included in the training data set in units of words. As a result, each specification is converted into an array of words (which will be referred to as a “word string” below).

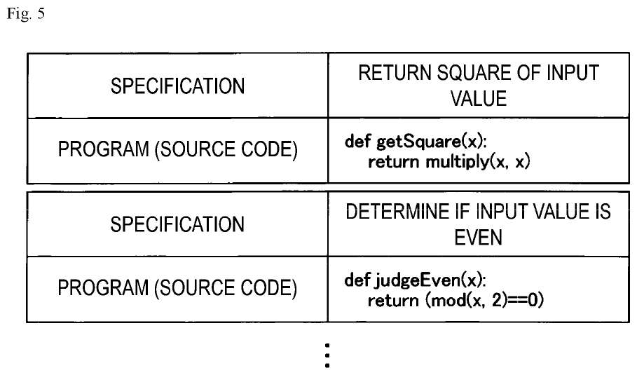

FIG. 5 is a diagram showing an example of a training data set. In FIG. 5, one table corresponds to one piece of training data. The data structure of the training data set is as follows if it is described in the format based on the Backus-Naur form (BNF).
<Training data set>::=[specification source code]+

That is, the training data set is a set of one or more pieces of training data composed of the specification described in natural language and the source code of the program. A plurality of such training data sets are prepared in advance and stored in, for example, the auxiliary storage device 102.

Next, the training unit 11 disassembles (divides) the source code of each piece of the training data included in the training data set in units of tokens (S102). As a result, each source code is converted into an array of tokens (which will be referred to as a “token string”). Further, “token” refers to a sequence of characters in a smallest unit with a meaning in the code when a compiler or the like analyzes the source code of the program.

Next, the training unit 11 causes the generation model to train the relationship between the word string and the token string of the training data for each piece of the training data (S103).

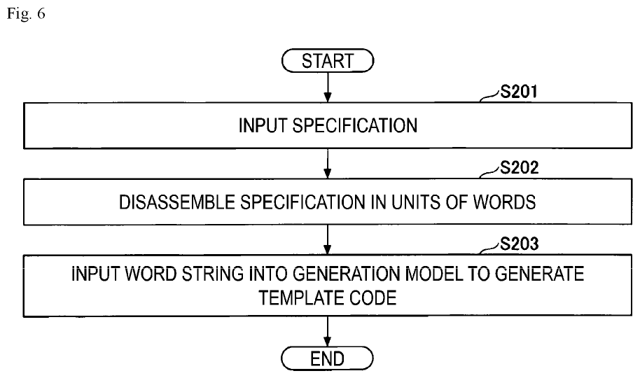

Next, details of step S20 of FIG. 3 will be described. FIG. 6 is a flowchart for explaining an example of the processing procedure of the template code generation process.

In step S201, the template code generation unit 12 inputs a specification of the target program (which will be referred to as a “target specification” below). The target specification is stored in the auxiliary storage device 102 in advance, for example.

Next, the template code generation unit 12 disassembles the target specification in units of words (S202). As a result, the array of words (word string) included in the target specification is generated.

Next, the template code generation unit 12 generates the source code (template code) of the target program by inputting the word string into the generation model (S203). That is, the token string of the target program is output from the generation model, and the template code is obtained in accordance with the token string.

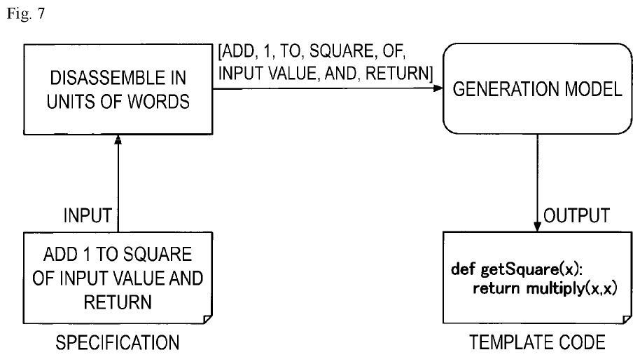

FIG. 7 is a diagram illustrating a specific example of the template code generation process. FIG. 7 illustrates a specific example of a specification, a specific example of a word string based on the specification, and a specific example of a template code output from a generation model by inputting the word string into the generation model.

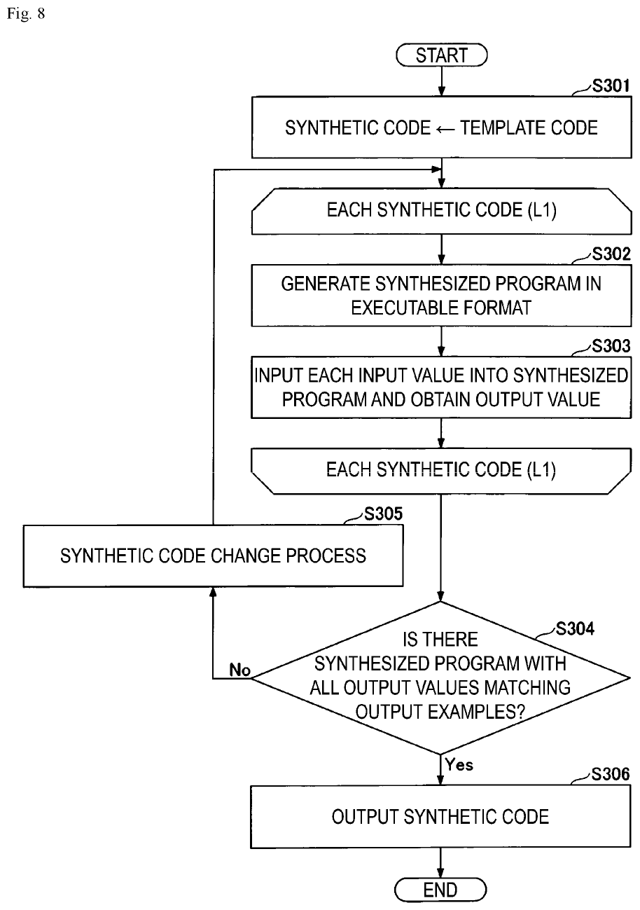

Next, details of step S30 in FIG. 3 will be described. FIG. 8 is a flowchart for explaining an example of a processing procedure of a program synthesis process.

In step S301, the program synthesis unit 13 sets a template code to a synthetic code. Step S301 is merely a change of the name.

Next, loop processing L1 including steps S302 and S303 is performed for each synthetic code. A synthetic code to be processed in the loop processing L1 is hereinafter referred to as a “target code”. However, the synthetic code that is subject to the loop processing L1 first is one template code.

In step S302, the synthesized program execution unit 14 generates a program in an executable format (which will be referred to as a “synthesized program” below) by compiling and linking target codes.

Next, the synthesized program execution unit 14 inputs an input value of each input/output example included in an input/output example set that is prepared in advance to the synthesized program (which will be referred to as a “target synthesized program” below), executes the target synthesized program, and obtains an output value for each input/output example (S303). The input/output example set is information indicating a condition to be satisfied by the target program for input/output and is set in advance and stored in the auxiliary storage device 102, for example.

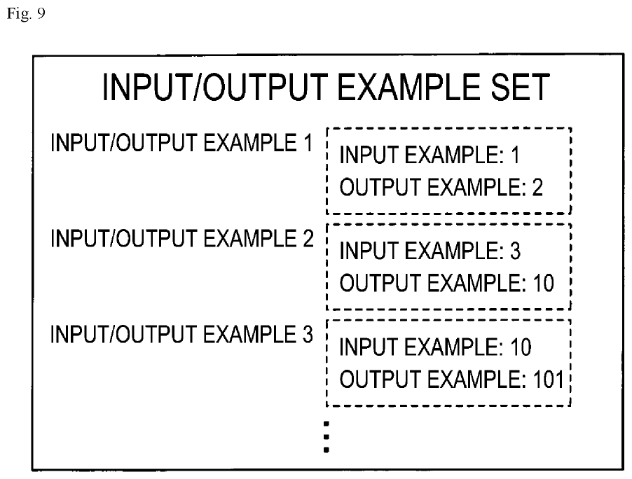

FIG. 9 is a diagram illustrating an example of the input/output example set. The data structure of the input/output example set illustrated in FIG. 9 can be described in the format based on the BNF notation as follows.
<input/output example set>::=<input/output example>+
<input/output example>::=<input example><output example>
<input example>::=input value+
<output example>::=output value+

That is, the input/output example set includes one or more input/output examples. One input/output example is a set of an input example and an output example. An input example has one or more input values, and an output example has one or more output values.

For example, in a case in which the number of input/output examples included in an input/output example set is M, the synthesized program execution unit 14 executes the target synthesized program using M input values as inputs for each input value, and thereby obtains M output values in step S303.

When the loop processing L1 ends, the input/output result determination unit 15 determines whether there is a synthesized program with all of the output values matching the output examples of the input/output examples to which the input values corresponding to the output values belong (S304). In other words, it is determined whether there is a synthesized program among synthesized programs to be processed in the loop processing L1 in which all of the output values obtained in step S303 are as expected (correct). Further, if step S304 is performed first, only one synthesized program generated in accordance with the template code is processed in the loop processing L1. Thus, in this case, a determination is made on the results of the input/output of the synthesized program in step S304.

If there is no applicable synthesized program (NO in S304), the program synthesis unit 13 executes a process of changing the synthetic code (S305). In the synthetic code change process, a part of the original synthetic code is changed to generate a plurality (N) of synthetic codes. A genetic algorithm may be used to change a part of the synthetic code, for example. That is, genetic manipulation may be performed N times on previous-generation synthetic codes to generate N next-generation synthetic codes. Here, N is the number of entities (source codes) in one generation of the genetic algorithm. At this time, each synthetic code to be applied to the genetic algorithm is expressed, for example, with a tree structure in which an operator is a parent node, and a variable, a constant, or an operator to be calculated using the operator is a child node, and a partial tree of the tree structure is subject to genetic manipulation. A pass rate of output values (a percentage of correct output values) may be used in an evaluation for selecting entities that are targets of N genetic manipulations,

In addition, program components included in a program component list stored in the auxiliary storage device 102 in advance, for example, are used as candidates to be replaced with a part of the previous-generation synthetic codes in a mutation.

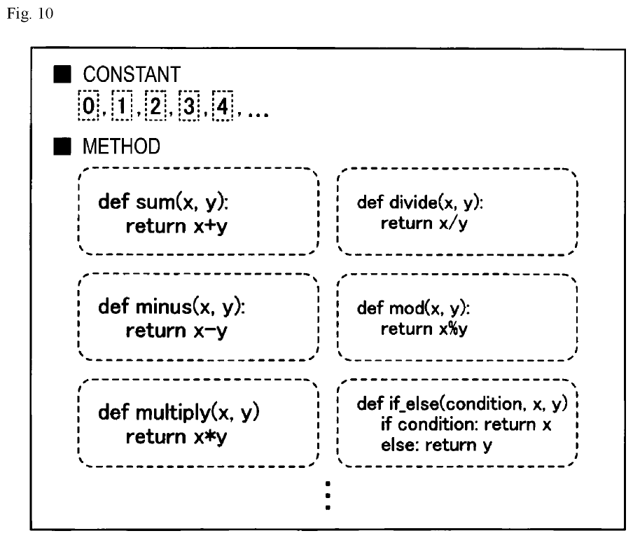

FIG. 10 is a diagram illustrating an example of a program component list. The data structure of the program component list illustrated in FIG. 10 can be described in the format based on the BNF notation as follows.
<program component list>::=program component+

That is, the program component list includes (a source code of) one or more program components. In FIG. 10, the program components are classified into constants and methods. Here, one constant corresponds to one program component, and one method corresponds to one program component. In other words, the unit surrounded by the dashed line in FIG. 10 corresponds to a unit of one program component.

Further, if step S305 is performed first, the previous-generation entity (synthetic code) is one template code. Thus, the same N synthetic codes are generated by copying the corresponding template code in this case, and genetic manipulation may be performed N times on the N synthetic codes. As a result, N new synthesized programs are generated.

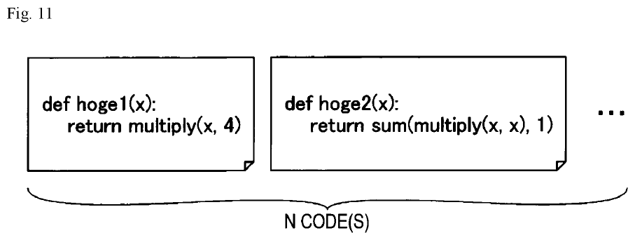

FIG. 11 is a diagram illustrating an example of synthetic codes generated through a synthetic code change process. As illustrated in FIG. 11, N synthetic codes are generated in a single synthesis process.

Further, an existing library such as DEAP (https://deap.readthedocsio/en/master/) may be used for a program synthesis process using a genetic algorithm.

Then, the loop processing L1 and subsequent processing are performed for N synthetic codes. Thus, in this case, steps S302 and S303 are performed N times.

On the other hand, if there is a synthesized program satisfying the condition of step S304 (YES in S304), the input/output result determination unit 15 outputs the source code (synthetic code) of the synthesized program (S306). In other words, the synthesized program is determined to be the target program. Further, if there is a plurality of synthesized programs satisfying the condition of step S304, the source code of each of the synthesized programs is only required to be output.

For example, if the three input/output examples illustrated in FIG. 9 are all input/output examples included in the input/output example set, the second synthetic code from the left in FIG. 11 is output as (the source code of) the target program.

As described above, according to the present embodiment, a program that is expected to satisfy a specification (text string) is automatically generated using two pieces of information of the specification of a program described in natural language and an input/output example. That is, a template code is automatically generated using a generation model trained on the relationship between the natural language in which the specification (intention of the creator) of the program is described and the corresponding program, and the program is repeatedly changed (modified) until a program satisfying all input/output examples is generated in accordance with the template code. As a result, it is possible to increase the likelihood of a desired program being automatically generated as compared to the related art.

Further, in the present embodiment, the template code is an example of a first program. The template code generation unit 12 is an example of a generation unit. The program synthesis unit 13 is an example of a change unit. The target program is an example of a second program.

Although the embodiment of the present disclosure has been described in detail above, the present disclosure is not limited to such specific embodiment, and various alterations and modifications can be made within the scope of the gist of the present disclosure described in the aspects.

### REFERENCE SIGNS LIST

10 Program generation apparatus

11 Training unit

12 Template code generation unit

13 Program synthesis unit

14 Synthesized program execution unit

15 Input/output result determination unit

100 Drive device

101 Recording medium

102 Auxiliary storage device

103 Memory device

104 CPU

105 Interface device

106 Display device

107 Input device

B Bus

1. A program generation apparatus comprising a processor configured to execute a method comprising:
receiving as an input a specification of a program to be generated described in natural language into a model trained on a relationship between the specification of a program described in natural language and the program to generate a first program; and
changing the first program to generate a second program satisfying one or more pairs of input values and output values.

2. The program generation apparatus according to claim 1, wherein
the changing the first program cumulatively repeats change of a part of the first program until the second program is generated.

3. The program generation apparatus according to claim 2, wherein
the changing the first program further comprises changing the part of the first program by using a plurality of program parts.

4. A computer implemented method for generating programs, comprising:
receiving as input a specification of a program to be generated described in natural language into a model trained on a relationship between a specification of a program described in natural language and the program to generate a first program; and
changing the first program to generate a second program satisfying a set of one or more input values and output values.

5. The program generation method according to claim 4, wherein
the changing the first program further comprises a change of a part of the first program is cumulatively repeated until the second program is generated.

6. The program generation method according to claim 5, wherein
the changing the first program further comprises changing the part of the first program by using a plurality of program parts.

7. A computer-readable non-transitory recording medium storing computer-executable program instructions that when executed by a processor cause a computer to execute a method comprising:
receiving as input a specification of a program to be generated described in natural language into a model trained on a relationship between a specification of a program described in natural language and the program to generate a first program; and
changing the first program to generate a second program satisfying a set of one or more input values and output values.

8. The program generation apparatus according to claim 1, wherein the program parts include a source code of at least one of a constant or a method.

9. The program generation apparatus according to claim 1, wherein the model is configured as a recurrent neural network.

10. The program generation apparatus according to claim 1, the processor further configured to execute a method comprising:
disassembling the specification of a program in natural language into training data, wherein the training data includes an array of words; and
training, based on the training data, the model.

11. The program generation apparatus according to claim 1, the processor further configured to execute a method comprising:
generating the second program by compiling and linking a synthetic code based on the first program.

12. The computer implemented method according to claim 4, wherein the program parts include a source code of at least one of a constant or a method.

13. The computer implemented method according to claim 4, wherein the model is configured as a recurrent neural network.

14. The computer implemented method according to claim 4, the method further comprising:
disassembling the specification of a program in natural language into training data, wherein the training data includes an array of words; and
training, based on the training data, the model.

15. The computer implemented method according to claim 4, the method further comprising:
generating the second program by compiling and linking a synthetic code based on the first program.

16. The computer-readable non-transitory recording medium according to claim 7, wherein
the changing the first program cumulatively repeats change of a part of the first program until the second program is generated.

17. The computer-readable non-transitory recording medium according to claim 7, wherein
the changing the first program further comprises changing the part of the first program by using a plurality of program parts.

18. The computer-readable non-transitory recording medium according to claim 7, wherein the program parts include a source code of at least one of a constant or a method.

19. The computer-readable non-transitory recording medium according to claim 7, the computer-executable program instructions when executed further causing the computer to execute a method comprising:
disassembling the specification of a program in natural language into training data, wherein the training data includes an array of words; and
training, based on the training data, the model, wherein the model is configured as a recurrent neural network.

20. The computer-readable non-transitory recording medium according to claim 7, the computer-executable program instructions when executed further causing the computer to execute a method comprising:
generating the second program by compiling and linking a synthetic code based on the first program.
